(19) United States
(12) Patent Application Publication
(10) Pub. No.: US 2025/0062460 A1
(43) Pub. Date: Feb. 20, 2025

(54) AN ELECTRODE ROLL, AN ELECTRODE DISC AND A CYLINDRICAL SECONDARY CELL

(71) Applicant: NORTHVOLT AB, Stockholm (SE)

(72) Inventor: Tetsuya MAKINO, Solna (SE)

(21) Appl. No.: 18/720,930

(22) PCT Filed: Feb. 13, 2023
(86) PCT No.: PCT/EP2023/053491

§ 371 Date: Jun. 17, 2024

(30) Foreign Application Priority Data
Feb. 16, 2022 (SE) 2250157-1

(51) Int. Cl. H01M 50/179; H01M 10/0587; H01M 50/107; H01M 50/533; H01M 50/559

(52) U.S. Cl. CPC H01M 50/179; H01M 10/0587; H01M 50/107; H01M 50/533; H01M 50/559

(57) ABSTRACT

This disclosure presents an electrode roll (10) for a secondary cell (100) comprising a liquid electrolyte, the electrode roll (10) comprising an electrically conductive sheet (1) rolled (1′) along its longitudinal axis (X) to form the electrode roll (10). The electrically conductive sheet (1) comprises a coated portion (2) provided with an electrode coating to form a positive or a negative electrode, and a contact portion (3) protruding from the coated portion (2) and bent (3′) to form an electrical contact surface (11) at an end surface of the electrode roll (10). The contact portion (3) does not extend along the entire length of the electrically conductive sheet (1), the electrical contact surface (11) is annular in shape and only forms a part of the end surface (13) of the electrode roll (10), and the electrical contact surface (11) forms 30 to 80 percent of the end surface (13) of the electrode roll (10). An electrode disc (20) is also presented.

### TECHNICAL FIELD

The present disclosure generally pertains to secondary cells, and more particularly to an electrode roll, an electrode disc and a cylindrical secondary cell comprising such and electrode roll and/or electrode disc.

### BACKGROUND

In addressing climate change, there is an increasing demand for rechargeable batteries, e.g. to enable electrification of transportation and to supplement renewable energy. Such batteries typically comprise a number of cells, often referred to as secondary cells.

In battery manufacturing it is known in the art to provide an electrically conductive sheet with a coating that is rolled up into a cylinder. In so called tabless cells, the electrically conductive sheet has an uncoated edge protruding on a side of the cylinder. The edge may be folded to provide an electrical contact surface.

As the demand for rechargeable batteries increases, more and more focus is being placed on production speed. To achieve an effective production of rechargeable batteries, the design of the batteries can be optimized

### SUMMARY

It is in view of the above considerations and others that the embodiments of the present invention have been made. The present disclosure aims at providing highly performance secondary cells that are efficient in manufacture.

According to a first aspect, the present disclosure provides an electrode roll for a secondary cell comprising a liquid electrolyte, the electrode roll comprising an electrically conductive sheet rolled along its longitudinal axis to form the electrode roll, the electrically conductive sheet comprising
a coated portion provided with an electrode coating to form a positive or a negative electrode, and
a contact portion protruding from the coated portion and bent to form an electrical contact surface at an end surface of the electrode roll,
   wherein the contact portion does not extend along the entire length of the electrically conductive sheet, the electrical contact surface is annular in shape and only forms a part of the end surface of the electrode roll, and wherein the electrical contact surface forms 30 to 80 percent of the end surface of the electrode roll.

Advantageously, since the electrical contact surface only forms a part of the end surface of the electrode roll, there is a remaining part of the end surface of the electrode roll that is free from an electrical contact surface. In other words, the electrical contact area forms a part of the end area of the electrode roll. The remaining part or area of the end surface of the electrode roll may be referred to as an electrolyte flow surface, as it readily allows the flow of electrolyte there through. The electrolyte flow surface may form 20 to 70 percent of the end surface of the electrode roll.

The annular shape of the electrical contact surface brings the advantage that it is easily accessible for electrical contact. The annular electrical contact surface is available to be electrically contacted at a known radial distance from the outer edge and from the center of the electrode roll. The annular electrical contact surface extends around the end surface of the electrode roll, such that it is available for electrical contact at any circumferential position of the annular electrical contact surface. The annular shape of the electrical contact surface may be obtained by the contact portion not extending to the inner end of the electrically conductive sheet. The bent, or folded, contact portion forms an uninterrupted, annular electrical contact surface. The annular electrical contact surface extends in a continuous annular shape on the end surface of the electrode roll.

As is to be apprehended, the annular electrical contact surface that is accomplished by folding the contact portion is relatively liquid tight. The liquid electrolyte that is comprised in the secondary cell does not flow easily through the electrical contact surface when the electrolyte is filled into the secondary cell during manufacture. The electrical contact surface shall preferably be relatively liquid tight and flat to provide good electrical contact. During manufacture, the electrical contact surface is typically brought in electrical contact with an electrode disc or a similar component that is in turn in electrical contact with a terminal of the secondary cell. The electrode disc or similar component is typically welded to the electrical contact surface, e.g. by laser welding.

A relatively large electrolyte flow surface is advantageous as the time required for filling the secondary cell, and thus the electrode roll, with liquid electrolyte may be reduced. This shortened time may reduce any oxidation of the coated portion of the electrically conductive sheet which may increase the performance of the secondary cell. On the other hand, if the electrical contact surface is too small, the electrical resistance of the electrode roll may become undesirably large.

The electrical contact surface may form 30 to 60, preferably 40 to 60 and most preferred 45 to 55 percent of the end surface of the electrode roll. In one embodiment, the electrical contact surface forms approximately 48 to 52 percent of the end surface of the electrode roll. A lager electrical contact surface facilitates electrically contacting it to an electrode disc or similar component, e.g. by welding. A larger electrical contact surface may also be beneficial for keeping the electrical resistance of the electrode roll low. On the other hand, as mentioned, a lager electrical contact surface hinders electrolyte flow.

The contact portion may extend to the outer end of the electrically conductive sheet, which outer end is arranged on the outer circumference surface of the electrode roll, such that the electrical contact surface is arranged at the outer edge of the end surface of the electrode roll. Such an electrical contact surface requires less radial extension to obtain a desired electrical contact area, as compared to an electrical contact surface arranged at a distance from the outer edge. In addition, an electrical contact surface is arranged at the outer edge of the end surface of the electrode roll may be particularly accessible for electrical contact to e.g. an electrode disc. The outer circumference surface may alternatively be referred to as outer circumferential surface.

Alternatively, the contact portion may not extend to the outer end of the electrically conductive sheet, which outer end is arranged on the outer circumference surface of the electrode roll, such that the electrical contact surface is arranged at a distance from the outer edge of the end surface of the electrode roll. Such an electrical contact surface may be of advantage as it may provide an electrolyte flow surface at the outer edge of the end surface of the electrode roll, which may be beneficial for electrolyte filling. In addition, such an electrical contact surface may lower the electrical resistance of the electrode roll as some parts of the electrically conductive sheet are distanced from the outer end thereof.

The contact portion may not extend to the inner end of the electrically conductive sheet, which inner end is arranged at the center of the electrode roll, such that the electrical contact surface is arranged at a distance from the center of the end surface of the electrode roll. Such an electrical contact surface may be of advantage as it may provide an electrolyte flow surface at the center of the end surface of the electrode roll, which may be beneficial for electrolyte filling. In addition, such an electrical contact surface may lower the electrical resistance of the electrode roll as some parts of the electrically conductive sheet are distanced from the inner end thereof. The inner end of the electrically conductive sheet may form the center of the electrode roll. There may be a cylindrical, e.g. circular cylindrical, though-opening through the center if the electrode roll.

The contact portion may not extend to the outer end of the electrically conductive sheet, which outer end is arranged on the outer circumference surface of the electrode roll. In addition, the contact portion may not extend to the inner end of the electrically conductive sheet, which inner end is arranged at the center of the electrode roll. Thereby, the electrical contact surface will be arranged at a distance from the outer edge and at a distance from the center of the end surface of the electrode roll. Such an electrical contact surface may be of advantage as it may provide electrolyte flow surfaces on both its sides, and as most parts of the electrically conductive sheet are relatively close. The contact portion may be arranged on the electrically conductive sheet such that the annular electrical contact surface is positioned essentially radially centrally on the end surface of the electrode roll. The contact portion may be arranged on the electrically conductive sheet such that a radially outer electrolyte flow surface and a radially inner electrolyte flow surface are defined, the inner and outer electrolyte flow surfaces may be of essentially the same area or may have essentially the same radial extensions.

The electrically conductive sheet may comprise two contact portions protruding from the coated portion at a distance from one another, such that the contact portions form two annular electrical contact surfaces at the end surface of the electrode roll. Such electrical contact surfaces may be of advantage both as regards electrolyte flow surfaces and as regards keeping the electrical resistance of the electrode roll low.

The electrical contact surface of a first end surface of the electrode roll may be of the same shape as the electrical contact surface of the second end surface of the electrode roll. Such a design may be beneficial for manufacture and assembly.

Alternatively, the electrical contact surface of a first end surface of the electrode roll may not be of the same shape as the electrical contact surface of the second end surface of the electrode roll. For example, the respective electrical contact surfaces may be optimised for increasing the electrolyte flow at a first, e.g. vertically lower, and a second, e.g. vertically higher, end of the electrode roll. For example, the electrical contact surface at the vertically lower end of the electrode roll may be optimised for capillary electrolyte flow during filling.

The electrical contact surface of a first end surface may not fully overlap the electrical contact surface of the second end surface. Such a design may be beneficial for the electrolyte flow. The respective electrical contact surface may be arranged such that there is no overlap, or such that the overlap is less than e.g. 10 or 20 percent of the largest contact surface. For example, at one end surface there may be two annular electrical contact surfaces while there is one single annular electrical contact surface at the other end surface. The two annular electrical contact surfaces may be radially arranged such that they essentially do not overlap the single annular electrical contact surface, or such that there is no overlap. In another example, there is one single annular electrical contact at one end surface and one single annular electrical contact surface at the other end surface. The respective single annular electrical contact surfaces may be radially arranged such that they essentially do not overlap one another, or do not overlap at all.

The contact portion is typically uncoated. The contact portion typically comprises a plurality of notches to facilitate folding.

According to a second aspect, the present disclosure provides an electrode disc for a secondary cell comprising an electrode roll and a liquid electrolyte, the electrode roll comprising an end surface a part of which is an annular electrical contact surface, wherein the electrode disc is of an annular shape that essentially conforms to the annular contact surface of the electrode roll, such that the electrode disc may electrically contact the annular electrical contact surface while allowing electrolyte flow through the electrode disc into the electrode roll.

The width of the annular electrical contact surface may be 7 to 18, preferably 8 to 15 and most preferred 10 to 12 millimeters. In embodiments with two annular electrical contact surfaces, the width of each one may be is 3 to 8, preferably 4 to 7 and most preferred 4.5 to 6.5 millimeters. An outer annular electrical contact surface may have a larger width than an inner annular electrical contact surface.

The advantages and further features of such an electrode disc are similar to the ones mentioned above in connection with the electrode roll. The shapes and dimensions of embodiments of the electrode disc may thus be the same as the shapes and dimension of the embodiments of the electrode roll. However, it is to be apprehended that the electrode disc may find use together with an electrode roll different from the one described above. The secondary cell is typically a cylindrical secondary cell.

The electrode disc may comprise at least one protrusion that protrudes radially from the electrode disc. Such a protrusion may be electrically connected to e.g. an outer can of the secondary cell, e.g. by welding. There may be a plurality of protrusions that are evenly distributed around the electrode disc outer circumference. Between the protrusion, the liquid electrolyte may flow though the electrode disc and into the electrode roll.

According to a third aspect, the present disclosure provides an electrode disc for a secondary cell comprising an electrode roll and a liquid electrolyte, the electrode roll comprising an end surface a part of which is two annular electrical contact surfaces, wherein the electrode disc is of a bi-annular shape that essentially conforms to the two annular electrical contact surfaces of the electrode roll, such that the electrode disc may electrically contact the annular electrical contact surfaces while allowing electrolyte flow through the electrode disc into the electrode roll. A plurality of electrically conducting bridges may connect the inner and outer annulus of the electrode disc.

The width of an annulus of a single annular electrode disc may be 7 to 18, preferably 8 to 15 and most preferred 10 to 12 millimeters. The width of each annulus of a bi-annular electrode disc may be is 3 to 8, preferably 4 to 7 and most preferred 4.5 to 6.5 millimeters.

According to a fourth aspect, the present disclosure provides an arrangement comprising an electrode roll according to any one of the above embodiments and an electrode disc according to any one of the above embodiments. According to a fifth aspect, the present disclosure provides a cylindrical secondary cell comprising an electrode roll according to any one of the above embodiments, and optionally an electrode disc according to any one of the above embodiments.

The cylindrical secondary cell may comprise an outer can of a radius larger than the radius of the electrode roll and an open mandrel around which the electrically conductive sheet is rolled, such that electrolyte flow paths are formed by the space between the outer can and the electrode roll and by the mandrel.

The electrical contact surface may form 30 to 80, preferably 30 to 60 and most preferred 40 to 60 percent of the end surface of the cylindrical secondary cell.

The advantages and further features of such a cylindrical secondary cell are similar to the ones mentioned above in connection with the electrode roll.

The above-described electrode roll, electrode disc, arrangement and cylindrical secondary cell may be for, or comprised in, a vehicle battery for propelling a vehicle. The vehicle may for example be a fully electrically propelled vehicle or a hybrid vehicle.

### BRIEF DESCRIPTION OF THE DRAWINGS

The embodiments disclosed herein are illustrated by way of example, and by not by way of limitation, in the figures of the accompanying drawings. Like reference numerals refer to corresponding parts throughout the drawings, in which

FIG. 1 schematically illustrates a first embodiment of an electrode roll for a secondary cell,

FIG. 2 shows a first embodiment of an electrode disc for a secondary cell,

FIG. 3 schematically illustrates an electrically conductive sheet before being rolled to form an electrode roll of the first embodiment,

FIG. 4 illustrates a second embodiment of an electrode roll for a secondary cell, and

FIG. 5 shows a second embodiment of an electrode disc for a secondary cell,

FIG. 6 schematically illustrates an electrically conductive sheet before being rolled to form an electrode roll of the second embodiment,

FIG. 7 schematically illustrates a cylindrical secondary cell comprising the electrode roll of the first embodiment,

FIG. 8 shows a third embodiment of an electrode disc for a secondary cell,

FIG. 9 schematically illustrates an electrically conductive sheet before being rolled to form an electrode roll of a third embodiment,

FIG. 10 shows a two electrically conductive sheets being rolled to form an electrically conductive sheet, and

FIG. 11 shows a sheet blank that can be cut to form two conductive sheets of the first, second or third embodiments.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

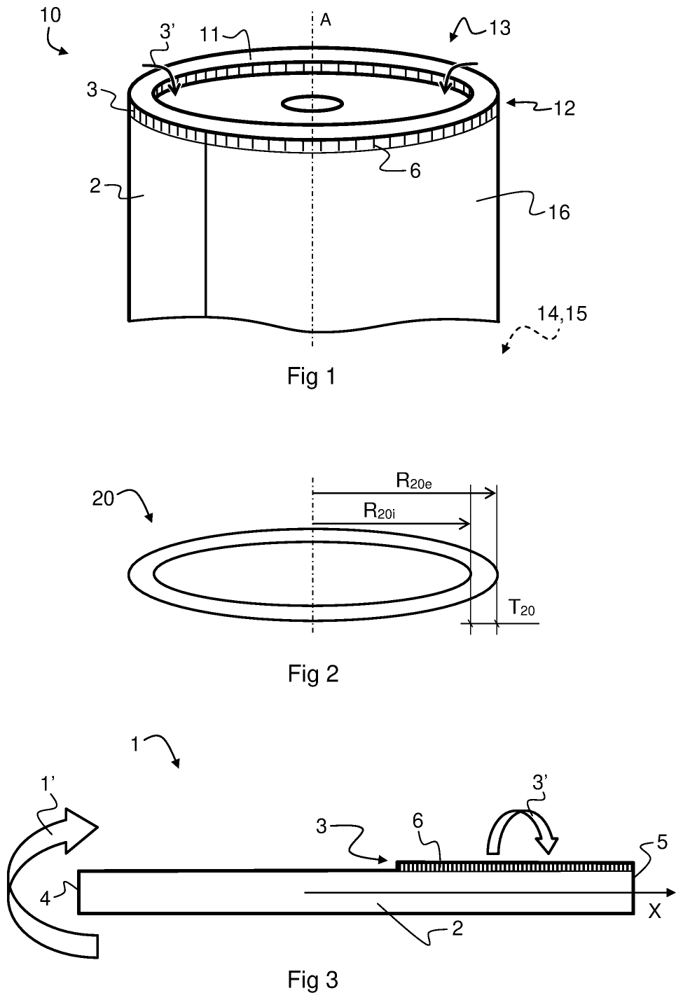

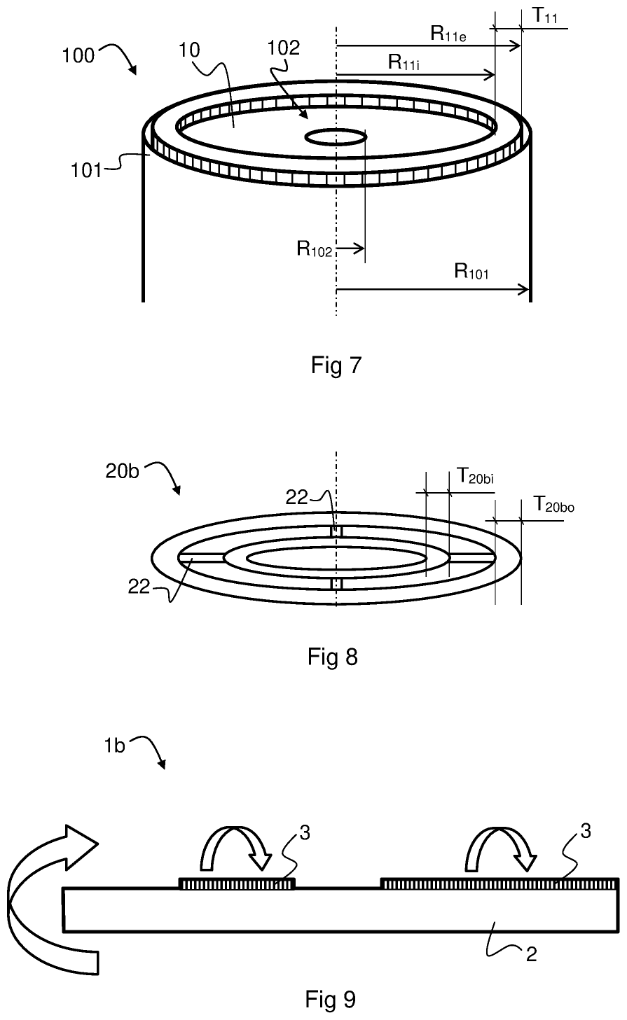

FIG. 1 illustrates a first embodiment of an electrode roll 10, sometimes referred to as a jelly roll, for a secondary cell 100 illustrated in FIG. 7. The secondary cell 100 comprises the electrode roll 10, a liquid electrolyte and further components, as will be described below. The electrode roll 10 is of a circular cylindrical shape and extends along a center axis A from a first end 12 to a second end 14 (not shown). The first end 12 (top end in FIG. 1) has a first end surface 13 and the second end 14 has a second end surface 15 (not shown). The electrode roll 10 further has an outer circumference surface 16.

FIG. 3 illustrates an electrically conductive sheet 1 that is rolled 1′ along its longitudinal axis or direction X to form the electrode roll 10 of FIG. 1. The electrically conductive sheet 1 is schematically illustrated in FIG. 3. It is to be apprehended that, for illustrative purposes, the length of the electrically conductive sheet 1 along its longitudinal axis X is very understated in relation to its height (transverse the longitudinal axis X). After the electrically conductive sheet 1 has been rolled 1′ to form the electrode roll 10, the longitudinal axis X is aligned with a plane that it orthogonal to the center axis A of the electrode roll 10.

As is indicated in FIGS. 1 and 3, the electrically conductive sheet 1 comprises a coated portion 2 provided with at least one electrode coating to form a positive or a negative electrode, and a contact portion 3 protruding from the coated portion 2 and bent 3′, or folded, to form an electrical contact surface 11 at the first end surface 13 of the electrode roll 10. In other words, the conductive sheet 1 comprises the contact portion 3 arranged along an end side (upper side in FIG. 3), or longitudinal end side, of the conductive sheet 1. The contact portion 3 is typically free of coating. The electrical contact surface 11 that is formed by the contact portion 3 may alternatively be referred to as a bent contact portion.

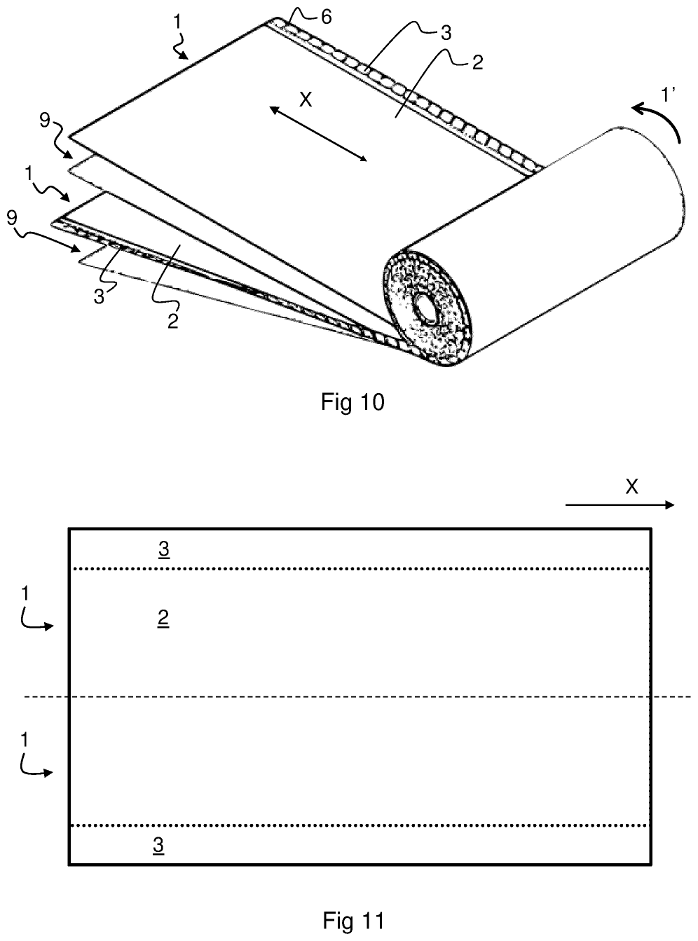

As is explained with reference to FIGS. 10 and 11 below, the electrode roll typically comprises a number of sheets and separators, but the focus of the present disclosure is on the electrical contact surface 11 of the electrode roll 10 formed by the electrically conductive sheet 1.

As is shown in FIG. 3, the contact portion 3 does not extend along the entire length (along the longitudinal direction X) of the electrically conductive sheet 1. In other words, the contact portion 3 extends along a part or section of the length of the electrically conductive sheet 1. Thus, the contact portion 3 of the electrically conductive sheet 1 is shorter than the coated portion 2 of the electrically conductive sheet 1.

Typically, the contact portion 3 does not extend to the inner end 4 of the electrically conductive sheet 1, 1a, 1b (see more below). As a result, the electrical contact surface 11 (FIG. 1) is annular in shape after the electrically conductive sheet 1 has been rolled 1′. The electrical contact surface 11 only forms a part of the first end surface 13 of the electrode roll 10. The electrical contact surface 11 is arranged at a radial distance from the center axis A of the electrode roll 10.

In accordance with the present disclosure, the electrical contact surface 11 forms 30 to 80 percent of the first end surface 13 of the electrode roll 10. In some embodiments, the electrical contact surface 11 forms 30 to 60, preferably 40 to 60 and most preferred 45 to 55 percent of the first end surface 13 of the electrode roll 10.

In the first embodiment of the electrode roll 10, the contact portion 3 extends to the outer end 5 of the electrically conductive sheet 1, as is illustrated in FIG. 3. The conductive sheet 1 has the shape of a rectangle with two long sides and two short sides. When rolled 1′, one short side 4 will be arranged in the center of the roll 10 and the opposing short side 5 will be arranged at the circumferential surface of the electrode roll 10. The short side 5 that will be arranged at the circumferential surface of the electrode roll 10 is thus referred to as the outer end 5 of the electrically conductive sheet 1. Thus, in the first embodiment, the annular electrical contact surface 11 is arranged at the outer edge of the first end surface 13 of the electrode roll 10, as in clearly shown in FIG. 1.

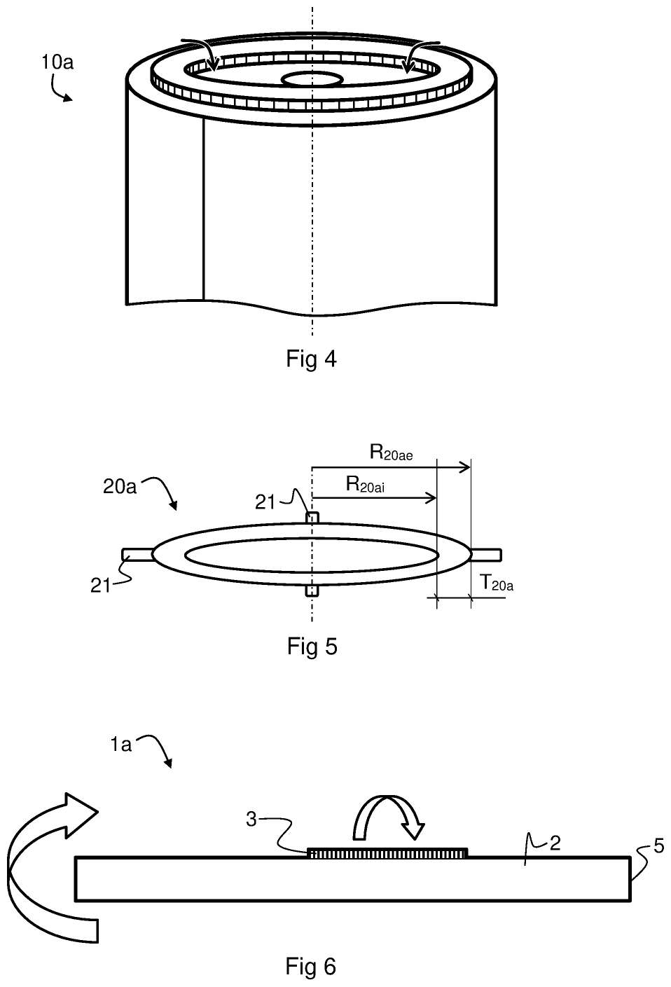

In the second embodiment of the electrode roll 10a, the annular electrical contact surface 11 is arranged at a (radial) distance from the outer edge of the first end surface 13 of the electrode roll 10a, as in clearly shown in FIG. 4. This is a result of the contact portion 3 not extending to the outer end 5 of the electrically conductive sheet 1a of the second embodiment, as is illustrated in FIG. 6.

In the third embodiment of the electrode roll 11b (not shown), there are two separate annular electrical contact surfaces 11. These two annular electrical contact surfaces 11 are (radially) distanced from one another, from the outer edge and from the center axis A of the electrode roll 11b. The shape of the upper surface of the electrode roll 11b of the third embodiment becomes clear from a study from FIGS. 8 and 9, in the context of the present disclosure.

Some further components of a secondary cell that is known per se will now be explained with reference to FIGS. 10 and 11. FIG. 10 shows an isometric view of a general electrode roll of a cylindrical secondary cell. The electrode roll normally consists of a first electrically conductive sheet 1 and a second electrically conductive sheet 1, both sheets 1 with respective electrode coating on a coated portion 2. The two electrically conductive sheets 1 are arranged with separator sheets 9 in between and rolled to an electrode roll. The electrode roll is shown in a state during the rolling 1′ of the conductive sheets 1 and the separators 9. In the electrode roll of a cylindrical secondary cell, the coating on one of the electrically conductive sheets 1 is a positive electrode and the coating of the other electrically conductive sheet is the negative electrode of the secondary cell.

An electrically conductive sheet 1 with a coated portion 2 provided with coating forming a positive electrode may for example be made of aluminium (aluminum in US English). A conductive sheet 1 with a coated portion 2 provided with coating forming a negative electrode may for example be made of copper. The conductive sheets 1 comprise one or more coatings, forming electrode coatings. Typically, notches 6 are cut, or otherwise formed, into the longitudinal side edges of the conductive sheets 1. As is illustrated in FIGS. 1, 3, 4, 6, 7 and 9 the notches 6 are formed in the contact portion 3 electrically conductive sheet 1, 1a, 1b. The notches 6 forms flaps which can be bent 3′ inwards to the rotation axis that forms the longitudinal axis A after the different stacked layers of the electrode roll are rolled up. The bending of the notches 6 of the contact portion 3 to form the electrical contact surface 11 is illustrated by curved arrows in FIGS. 1, 3, 4, 6 and 9.

The electrode roll is subsequently arranged in a can, or outer can, with terminals and parts connecting the electrical contact surfaces 11 of the electrode roll to terminals to form the cylindrical secondary cell. The cell can also include one or more vents and insulating parts. There are many ways to design these parts and they will not be described herein.

FIG. 11 shows a sheet blank that can be cut to form two electrically conductive sheets 1, 1a, 1b of the first, second or third embodiments. Two electrically conductive sheets are produced from one sheet blank which is cut in half (along the dotted central line) to form two separate electrically conductive sheets. The electrically conductive sheets 1, 1a, 1b are then provided as a coiled or rolled up continuous material on which a series of manufacturing steps are carried out, such as coating, rolling, pressing, heat treatment etc. These manufacturing steps are known per se and not descried in detail herein. It is possible to form the notches 6 at any state of the manufacturing process. The dotted lines indicate the coated portion 2 where the electrode coating is to be arranged on the conductive sheet. In other words, the electrode coating is to be arranged between the two dotted lines.

Only the first end 12 with the first end surface 13 of the electrode roll is shown in the figures depicting the present embodiments. The second end surface 15 of the second end 14 may have the same shape and dimension as the first end surface 13. Thus, the electrical contact surface 11 of the first end surface 13 may fully overlap the electrical contact surface 11 of the second end surface 15.

In alternative, the electrical contact surface 11 of the first end surface 13 of the electrode roll 10 may be different from the electrical contact surface 11 of the second end surface 15. For example, the electrical contact surface 11 of the first end surface 13 may be of a different shape and/or dimension as compared to the electrical contact surface 11 of the second end surface 15. Thus, the electrical contact surface 11 of the first end surface 13 may not fully overlap the electrical contact surface 11 of the second end surface 15, or the respective electrical contact surfaces 11 may not overlap at all.

FIG. 2 shows a first embodiment of an annular electrode disc 20 for a secondary cell. The electrode disc 20 may be brought in electrical contact, e.g. direct physical contact, with the above described electrical contact surface 11 of the electrode roll 10 of the first embodiment. The electrode disc 20 is in typically addition brought in electrical contact with a terminal of the secondary cell, typically via at least one further electrically conductive component. The electrode disc 20 may be brought in electrical contact, e.g. direct physical contact, e.g. by welding, with the outer can 101 of the secondary cell 100. A portion of the outer surface of the outer can 101 may form a terminal (typically the negative terminal) of the secondary cell 100.

As is shown, the electrode disc is of an annular shape with an internal radius denoted R₂₀ₑ and an external radius denoted R₂₀ᵢ. The width of the annulus is denoted T₂₀. Typically, when used together with the above described electrical contact surface 11 of the electrode roll 10 of the first embodiment, the electrode disc 20 is of the same shape and dimensions as the electrical contact surface 11.

FIG. 5 shows a second embodiment of an annular electrode disc 20a for a secondary cell. The electrode disc 20a may be brought in electrical contact with the above described electrical contact surface 11 of the electrode roll 10a of the second embodiment. The electrode disc 20a comprises a number of electrically conductive protrusions 21, in the examples four protrusions 21, which may be used for welding the electrode disc 20 to an outer can 101. As is apprehended from a study of FIGS. 4 and 5, a liquid electrolyte may flow on the outer side of the electrode disc 20a (between the protrusions 21) and also through the center opening of the electrode disc 20a into the electrode roll 10 (through the area not covered by the annular electrical contact surface 11).

FIG. 8 shows a third embodiment of an annular electrode disc 20b for a secondary cell, more precisely a bi-annual electrode disc 20b. The electrode disc 20b may be brought in electrical contact with the above described electrical contact surface 11 of the electrode roll of the third embodiment (formed by the electrically conductive sheet 1b shown in FIG. 9). The electrode disc 20b comprises a number of electrically conductive bridges 22, in the examples four bridges 22, that electrically connect the inner and outer annulus. The width of the outer annulus is denoted T_{20bo} and the width of the inner annulus is denoted T_{20bi}. A liquid electrolyte may flow between the outer an inner annulus (between the bridges 22) and through the center opening of the inner annulus into the electrode roll.

In bi-annual embodiments (not shown) of electrode rolls and electrode discs where the outer annulus is arranged at a distance from the outer edge of the end surface (see FIG. 4, disclosing one single such annulus), the electrode discs may comprise protrusions 21 and bridges 22.

In the first embodiment of the electrode roll 10 illustrated in FIGS. 1 and 7, the following dimensions apply (all dimensions exemplified herein apply after the contact the portion 3 has been bent to form the electrical contact surface 11):
R₁₀₁=23, a plausible range being 20-25, a preferred range being 22-24
R₁₀₂=3.5, a plausible range being 1.5-6, a preferred range being 3-4
R₁₁ₑ=20, a plausible range being 15-23, a preferred range being 19-21
R₁₁ᵢ=9, a plausible range being 7-13, a preferred range being 8-10
T₁₁=11, a plausible range being 7-18 a preferred range being 10-12

Where, as is clear from the figures, R₁₀₁ is the can radius, R₁₀₂ is the mandrel radius, R₁₁ₑ is the electrical contact surface external radius, R₁₁ᵢ is the electrical contact surface internal radius and T₁₁ is the width of electrical contact surface. The inner radius of the electrode roll is typically essentially equal to the mandrel radius R₁₀₂. The dimensions exemplified herein are given in millimeters (mm). Corresponding dimensions may apply to the first embodiment of the electrode disc shown in FIG. 2, in other words T₁₁ may equal T₂₀ and so on.

In the second embodiment of the electrode roll 10a illustrated in FIG. 4 (arrows indicating measurements shown in FIG. 7), the following dimensions apply:
R₁₁ₑ=17, a plausible range being 13-21, a preferred range being 15-19
R₁₁ᵢ=6, a plausible range being 3.5-9, a preferred range being 5-7
T₁₁=11, a plausible range being 7-18, a preferred range being 10-12

Corresponding dimensions may apply to the second embodiment of the electrode disc shown in FIG. 5.

The third embodiment of the electrode roll 10b is not shown, but the shape of is upper surface is clear from a study from FIGS. 8 and 9, in the context of the present disclosure. There are two separate electrical contact surfaces 11, each in form of an annulus formed by a bent contact portion 3. The following dimensions apply:
R₁₁ₒₑ=20, a plausible range being 17-23 a preferred range being 19-22
R₁₁ₒᵢ=15, a plausible range being 12-18 a preferred range being 14-17
R₁₁ᵢₑ=11, a plausible range being 7-18 a preferred range being 10-12
R₁₁ᵢᵢ=5.5, a plausible range being 3.5-8 a preferred range being 4-7
T₁₁ₒ=5.5, a plausible range being 3-8 a preferred range being 4.5-6.5
T₁₁ᵢ=5.5, a plausible range being 3-8 a preferred range being 4.5-6.5

Where R₁₁ₒₑ is the outer electrical contact surface external radius, R₁₁ₒᵢ is the outer electrical contact surface internal radius, R₁₁ᵢₑ is the inner electrical contact surface external radius, R₁₁ᵢᵢ is the inner electrical contact surface internal radius, T₁₁ₒ is the width of the outer electrical contact and T₁₁ᵢ is the width of the inner electrical contact.

Corresponding dimensions may apply to the third embodiment of the electrode disc shown in FIG. 6.

It is to be noted that the reference sign 11 is used for the electrical contact surfaces of all embodiments. Instead, the electrical contact surface of the first embodiment may be denoted 11, the electrical contact surface of the second embodiment may be denoted 11a, the outer electrical contact surface of the third embodiment may be denoted 11bₒ and the inner electrical contact surface of the third embodiment may be denoted 11bᵢ, jointly the latter two may be denoted 11b.

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1-15. (canceled)

15. An electrode roll (10) for a secondary cell (100) comprising a liquid electrolyte, the electrode roll (10) comprising an electrically conductive sheet (1) rolled (1′) along its longitudinal axis (X) to form the electrode roll (10), the electrically conductive sheet (1) comprising:
a coated portion (2) provided with an electrode coating to form a positive or a negative electrode, and
a contact portion (3) protruding from the coated portion (2) and bent (3′) to form an electrical contact surface (11) at an end surface of the electrode roll (10),
wherein:
the contact portion (3) does not extend along the entire length of the electrically conductive sheet (1),
the electrical contact surface (11) is annular in shape and only forms a part of the end surface (13) of the electrode roll (10), and
the electrical contact surface (11) forms 30 to 80 percent of the end surface (13) of the electrode roll (10).

16. The electrode roll (10) of claim 15, wherein the electrical contact surface (11) forms 30 to 60, preferably 40 to 60 and most preferred 45 to 55 percent of the end surface (13) of the electrode roll (10).

17. The electrode roll (10; 10b) of claim 15, wherein the contact portion (3) extends to the outer end (5) of the electrically conductive sheet (1; 1b), which outer end (5) is arranged on the outer circumference surface (16) of the electrode roll (10; 10b), such that the electrical contact surface (11) is arranged at the outer edge of the end surface (13) of the electrode roll (10; 10b).

18. The electrode roll (10a) of claim 15, wherein the contact portion (3) does not extend to the outer end (5) of the electrically conductive sheet (1a), which outer end (5) is arranged on the outer circumference surface (16) of the electrode roll (10a), such that the electrical contact surface (11) is arranged at a distance from the outer edge of the end surface (13) of the electrode roll (10a).

19. The electrode roll (10a) of claim 15, wherein the contact portion (3) does not extend to the outer end (5) of the electrically conductive sheet (1a), which outer end (5) is arranged on the outer circumference surface (16) of the electrode roll (10a), and wherein the contact portion (3) does not extend to the inner end (4) of the electrically conductive sheet (1a), which inner end (4) is arranged at the center of the electrode roll (10a), such that the electrical contact surface (11) is arranged at a distance from the outer edge and at a distance from the center of the end surface (16) of the electrode roll (10a).

20. The electrode roll (10b) of claim 15, wherein the electrically conductive sheet (1b) comprises two contact portions (3) protruding from the coated portion (2) at a distance from one another, such that the contact portions (3) form two annular electrical contact surfaces (11) at the end surface of the electrode roll (10b).

21. The electrode roll (10) of claim 15, wherein an electrical contact surface (11) of a first end surface (13) of the electrode roll (10) is not of the same shape and/or dimension as the electrical contact surface (11) of the second end surface (15) of the electrode roll (10).

22. The electrode roll (10) of claim 21, wherein the electrical contact surface (11) of the first end surface (13) does not fully overlap the electrical contact surface (11) of the second end surface (15).

23. An electrode disc (20) for a secondary cell (100) comprising an electrode roll (10) and a liquid electrolyte, the electrode roll (10) comprising an end surface (13) a part of which is an annular electrical contact surface (11), wherein the electrode disc (20) is of an annular shape that essentially conforms to the annular contact surface (11) of the electrode roll (10), such that the electrode disc (20) may electrically contact the annular electrical contact surface (11) while allowing electrolyte flow through the electrode disc (20) into the electrode roll (10).

24. The electrode disc (20; 20a; 20b) of claim 23, wherein the width (T₂₀; T₂₀ₐ) of an annulus of a single annular electrode disc (20; 20a) is 7 to 18, preferably 8 to 15 and most preferred 10 to 12 millimeters, and wherein the width (T_{20b}) of each annulus of a bi-annular electrode disc (20b) is 3 to 8, preferably 4 to 7 and most preferably 4.5 to 6.5 millimeters.

25. An electrode disc (20b) for a secondary cell (100) comprising an electrode roll (10b) and a liquid electrolyte, the electrode roll (10b) comprising an end surface (13) a part of which is two annular electrical contact surfaces (11), wherein the electrode disc (20b) is of a bi-annular shape that essentially conforms to the two annular electrical contact surfaces (11) of the electrode roll (10b), such that the electrode disc (20b) may electrically contact the annular electrical contact surfaces (11) while allowing electrolyte flow through the electrode disc (20b) into the electrode roll (10b).

26. The electrode disc (20; 20a; 20b) of claim 25, wherein the width (T₂₀; T₂₀ₐ) of an annulus of a single annular electrode disc (20; 20a) is 7 to 18, preferably 8 to 15 and most preferred 10 to 12 millimeters, and wherein the width (T_{20b}) of each annulus of a bi-annular electrode disc (20b) is 3 to 8, preferably 4 to 7 and most preferably 4.5 to 6.5 millimeters.

27. An arrangement (10; 10a; 10b, 20; 20a; 20b) comprising an electrode roll (10; 10a; 10b) according to claim 15 and an electrode disc (20; 20a; 20b) comprising an electrode roll (10) and a liquid electrolyte, the electrode roll (10) comprising an end surface (13) a part of which is an annular electrical contact surface (11), wherein the electrode disc (20) is of an annular shape that essentially conforms to the annular contact surface (11) of the electrode roll (10), such that the electrode disc (20) may electrically contact the annular electrical contact surface (11) while allowing electrolyte flow through the electrode disc (20) into the electrode roll (10).

28. A cylindrical secondary cell (100) comprising the electrode roll (10) of claim 15.

29. The cylindrical secondary cell (100) of claim 28, comprising an outer can (101) of a radius larger than the radius of the electrode roll (10) and an open mandrel (102) around which the electrically conductive sheet (1) is rolled (1′), such that electrolyte flow paths are formed by the space between the outer can (101) and the electrode roll (10) and by the mandrel (102).

30. The cylindrical secondary cell (100) of claim 29, wherein the electrical contact surface (11) forms 30 to 80, preferably 30 to 60 and most preferably 40 to 60 percent of the end surface of the cylindrical secondary cell (100).
